(19) United States
(12) Patent Application Publication
(10) Pub. No.: US 2002/0135641 A1
(43) Pub. Date: Sep. 26, 2002

(54) INK JET RECORDING HEAD, SUBSTRATE FOR THIS HEAD, MANUFACTURING METHOD OF THIS SUBTRATE AND INK JET RECORDING APPARATUS

(76) Inventors: TERUO OZAKI, YOKOHAMA-SHI (JP); MASAHIKO OGAWA, TOKYO (JP); TOMOYUKI HIROKI, ZAMA-SHI (JP); MUGA MOCHIZUKI, YOKOHAMA-SHI (JP)

Correspondence Address: FITZPATRICK CELLA HARPER & SCINTO, 30 ROCKEFELLER PLAZA, NEW YORK, NY, 10112, US

(21) Appl. No.: 09/210,800

(22) Filed: Dec. 15, 1998

(30) Foreign Application Priority Data
Dec. 18, 1997 (JP) 09-349335

(51) Int. Cl. B41J 2/05

(52) U.S. Cl. 347/64

(57) ABSTRACT

In ink jet recording head in which a heating resistor forming a heating portion, a wiring electrically connected to the heating resistor, and a protecting film formed on the heating resistor and the wiring to protect the heating resistor and the wiring are arranged on a substrate for the ink jet recording head, and an ink path communicated with a discharging port for discharging ink is formed on the substrate for the ink jet recording head, the protecting film includes a first layer protecting film for covering the heating resistor and the wiring, a second layer protecting film formed on the first layer protecting film by a material different from that of the first layer protecting film and having an opening in a portion corresponding to the heating portion of the heating resistor and constructed by an inorganic material, and a third layer protecting film constructed by the same material system as the first layer protecting film and covering the second layer protecting film and the first layer protecting film exposed from the opening.

### BACKGROUND OF THE INVENTION

1. Field of the Invention

The present invention relates to an ink jet recording head for performing a recording operation by discharging ink, a substrate for this head, a manufacturing method of this substrate and an ink jet recording apparatus.

2. Related Background Art

In an ink jet recording system disclosed in U.S. Pat. Nos. 4,723,129 or 4,740,796, etc., a recording operation can be performed at high speed with high density, high accuracy and high image quality, and this system is suitable for coloring and compactness. A recording head using this ink jet recording system and discharging ink to a recording medium by bubbling this ink by utilizing thermal energy is generally constructed such that a heating resistor for generating a bubble in the ink and a wiring for performing an electrical connection with this heating resistor are made on the same substrate and this substrate is set to a substrate for the ink jet recording head. Further, a nozzle for discharging the ink is generally formed on this substrate.

This substrate for the ink jet recording head has various means for saving applied electric energy on the one hand and preventing a reduction in life of the substrate caused by mechanical damage caused by the bubbling of the ink and the destruction of a heating portion caused by a thermal pulse on the other hand. In particular, this substrate has many means with respect to a protecting film for protecting the heating resistor having the heating portion located between a pair of wiring patterns from the ink.

In view of thermal efficiency, it is advantageous that this protecting film has high thermal conductivity or is thinner. However, it is advantageous from the mechanical damage and the probability of a defect in the protecting film caused by the bubbling of the ink that the protecting film is thicker. Further, the protecting film has a function for protecting the wiring connected to the heating resistor from the ink. The thickness of the protecting film is further restricted by a protecting object of a wiring portion rather than a heating resistor portion.

These contents will next be described in detail. A surface of the heating resistor is generally very smooth and the protecting film on this surface can be closely formed. In contrast to this, the wiring is generally formed by aluminum (Al) and a surface of this aluminum tends to be influenced by heat at a manufacturing time and relatively has irregularities. Further, this aluminum has about 500 nm in thickness so that a quality of the protecting film in a step difference portion tends to become bad. It is required from the above respects that the protecting film has a certain thickness and actually has about 1 μm in thickness.

Japanese Laid-Open Patent Application No. 08-112902 describes a method for partially reducing the thickness of the protecting film on the heating resistor to reduce this thickness as much as possible and stabilize the protecting function on the wiring. In this method, applied energy can be reduced and life of the recording head can be stabilized by reducing only the protecting film on the heating resistor.

However, in this.example, a heating resistor and a wiring pattern are first formed on a silicon oxide film as a substrate. Next, silicon oxide is formed as a first layer protecting film. Next, the protecting film on a heating portion of the heating resistor is partially removed therefrom by patterning. Finally, silicon nitride is formed as a second layer protecting film. Therefore, there are the following problems.

The protecting film is normally partially removed from the heating portion by wet etching. An etching liquid is constructed by using an etching liquid based on hydrogen fluoride if the first layer protecting film is formed by the silicon oxide. Further, the heating resistor is generally constructed by HfB₂ and TaN, but these materials are not damaged by the etching liquid based on the hydrogen fluoride.

Here, there is no problem in a manufacturing process when a removing portion of the protecting film is locally formed on an inner side by about several μm from an area of the heating portion of the heating resistor. However, thermal efficiency is reduced since this removing portion becomes a relatively small area on the inner side in comparison with a total area of the heating portion.

In contrast to this, when the first layer protecting film is formed while a step difference between the wiring, the heating resistor and the substrate below the heating resistor is covered, there is a case in which the quality of the first layer protecting film becomes bad in this step difference portion. Therefore, when the first layer protecting layer is widely removed in comparison with the heating portion of the heating resistor, a portion near the step difference between the heating resistor and the substrate below this heating resistor is etched. Accordingly, undercut is advanced along the step difference portion having a relatively bad film quality so that an air hole is caused in the film interior. As a result, there is a case in which life of the substrate for the head is reduced. Here, it is also considered that the quality of the first layer protecting film in the step difference portion becomes bad since vertical etching is often adopted as etching of the heating resistor to provide a fine structure and a cross section of this heating resistor approximately rises steeply at 90°. Accordingly, it was necessary to strictly control an etching time of the first layer protecting film so as to reduce the undercut as much as possible.

### SUMMARY OF THE INVENTION

An object of the present invention is to provide an ink jet recording head, a substrate for this head, a manufacturing method of this substrate and an ink jet recording apparatus for solving the above problems and widely utilizing a heating portion of a heating resistor as much as possible and easily controlled in process and having long lives while a saving energy structure is formed with high thermal efficiency.

Another object of the present invention is to provide an ink jet recording head in which a heating resistor forming a heating portion, a wiring electrically connected to the heating resistor, and a protecting film formed on the heating resistor and the wiring to protect the heating resistor and the wiring are arranged on a substrate for the ink jet recording head, and an ink path communicated with a discharging port for discharging ink is formed on the substrate for the ink jet recording head, the protecting film including a first layer protecting film for covering the heating resistor and the wiring, a second layer protecting film formed on the first layer protecting film by a material different from that of the first layer protecting film and having an opening in a portion corresponding to the heating portion of the heating resistor and constructed by an inorganic material, and a third layer protecting film constructed by the same material system as the first layer protecting film and covering the second layer protecting film and the first layer protecting film exposed from the opening.

Another object of the present invention is to provide a substrate for an ink jet recording head in which a heating resistor forming a heating portion, a wiring electrically connected to the heating resistor, and a protecting film formed on the heating resistor and the wiring to protect the heating resistor and the wiring are arranged on the substrate, the protecting film including a first layer protecting film for covering the heating resistor and the wiring, a second layer protecting film formed on the first layer protecting film by a material different from that of the first layer protecting film and having an opening in a portion corresponding to the heating portion of the heating resistor and constructed by an inorganic material, and a third layer protecting film constructed by the same material system as the first layer protecting film and covering the second layer protecting film and the first layer protecting film exposed from the opening.

Still another object of the present invention is to a manufacturing method of a substrate for an ink jet recording head in which a heating resistor forming a heating portion, a wiring electrically connected to the heating resistor, and a protecting film formed on the heating resistor and the wiring to protect the heating resistor and the wiring are arranged on the substrate, the method comprising the steps of forming a first layer protecting film so as to cover the heating resistor and the wiring, forming a film of an inorganic material different from a material of the first layer protecting film on the first layer protecting film, etching the film of the inorganic material in a portion corresponding to the heating portion of the heating resistor and removing this inorganic material film from this corresponding portion so that a second layer protecting film having an opening in the corresponding portion is formed, and forming a third layer protecting film of the same material system as the first layer protecting film so as to cover the second layer protecting film and the first layer protecting film exposed from the opening.

In the present invention, since the heating resistor and the wiring are covered with the first layer protecting film, a step difference in corner portions of the heating resistor and a pattern of the wire is relaxed. Accordingly, quality of the second layer protecting film formed on the first layer protecting film is improved and no overetching is substantially advanced along a step difference portion even when the second layer protecting film is etched.

The third layer protecting film of the same material system as the first layer protecting film becomes a protecting film of the heating portion together with the first layer protecting film left on the heating portion. Further, the third layer protecting film is laminated with the first and second layer protecting films thereon so that a protecting film having at least a three-layer structure is formed on the wiring. Thus, the films are formed by dividing these films into plural layers. Accordingly, when there is a defect in any portion of a protecting film of one layer, it is possible to extremely reduce the occurrence probability of a defect caused in any portion of the entire protecting film of a plural-layer structure.

Thus, in accordance with the present invention, it is possible to provide an ink jet recording head, a substrate for this head, a manufacturing method of this substrate and an ink jet recording apparatus for saving energy and having stable lives and convenient in process control.

### BRIEF DESCRIPTION OF THE DRAWINGS

FIG. 1 is a typical side sectional view showing one example of a substrate for an ink jet recording head of the present invention.

FIG. 2 is a typical plan view showing one example of the substrate for the ink jet recording head of the present invention.

FIGS. 3A, 3B, 3C and 3D are typical side sectional views showing a manufacturing process of the substrate for the ink jet recording head of the present invention.

FIGS. 4E, 4F and 4G are typical side sectional views similar to FIGS. 3A, 3B, 3C and 3D and showing a manufacturing process of the substrate for the ink jet recording head of the present invention.

FIG. 5 is a typical partially broken perspective view showing a main portion of the ink jet recording head of the present invention.

FIG. 6 is a typical perspective view showing a main portion of an ink jet recording apparatus of the present invention.

### DESCRIPTION OF THE PREFERRED EMBODIMENTS

An ink jet recording head in the present invention has a structure in which a heating resistor forming a heating portion, a wiring electrically connected to the heating resistor, and a protecting film formed on the heating resistor and the wiring to protect the heating resistor and the wiring are arranged on a substrate for the ink jet recording head, and an ink path communicated with a discharging port for discharging ink is formed on the substrate for the ink jet recording head. The protecting film includes a first layer protecting film for covering the heating resistor and the wiring, a second layer protecting film formed on the first layer protecting film by a material different from that of the first layer protecting film and having an opening in a portion corresponding to the heating portion of the heating resistor and constructed by an inorganic material, and a third layer protecting film constructed by the same material system as the first layer protecting film and covering the second layer protecting film and said first layer protecting film exposed from the opening.

In the present invention, the material of the second layer protecting film is mainly formed by a material different from that of the first layer protecting film for reasons in manufacture. An opening of the second layer protecting film is normally formed by etching. Accordingly, it is preferable that the second layer protecting film is formed by a material easily etched in comparison with the first layer protecting film. Namely, it is preferable to select this material such that an etching speed of the second layer protecting film material is higher than that of the first layer protecting film material. It is particularly preferable that a selecting ratio (the etching speed of the second layer protecting film material/the etching speed of the first layer protecting film material) is 10 or more. It is further preferable that this selecting ratio is 20 or more.

In the present invention, the first and third layer protecting films are formed by the same material system mainly in view of close attaching strengths of these films in the opening of the heating portion. Here, as mentioned above, the second layer protecting film is formed by a material different from the materials of the first and third layer protecting films, but is preferably formed by the same material system as the first and third layer protecting films. It is particularly preferable that “the same material system” is a material including silicon. It is suitable that the first and third layer protecting films are formed by silicon nitride as such a material and the second layer protecting film is formed by silicon oxide as such a material.

It is preferable to form the second layer protecting film by silicon oxide including boron or phosphorus since an etching rate difference between the second layer protecting film and the silicon nitride film can be further increased.

In the present invention, the first layer protecting film normally has a thickness from 0.01 to 0.5 μm, preferably a thickness from 0.01 to 0.1 μm. The second layer protecting film normally has a thickness from 0.3 to 1.5 μm, preferably a thickness from 0.5 to 1.0 μm. The third layer protecting film normally has a thickness from 0.1 to 1.0 μm, preferably a thickness from 0.1 to 0.5 μm.

The present invention will next be further explained in detail by showing embodiments.

### Embodiment 1

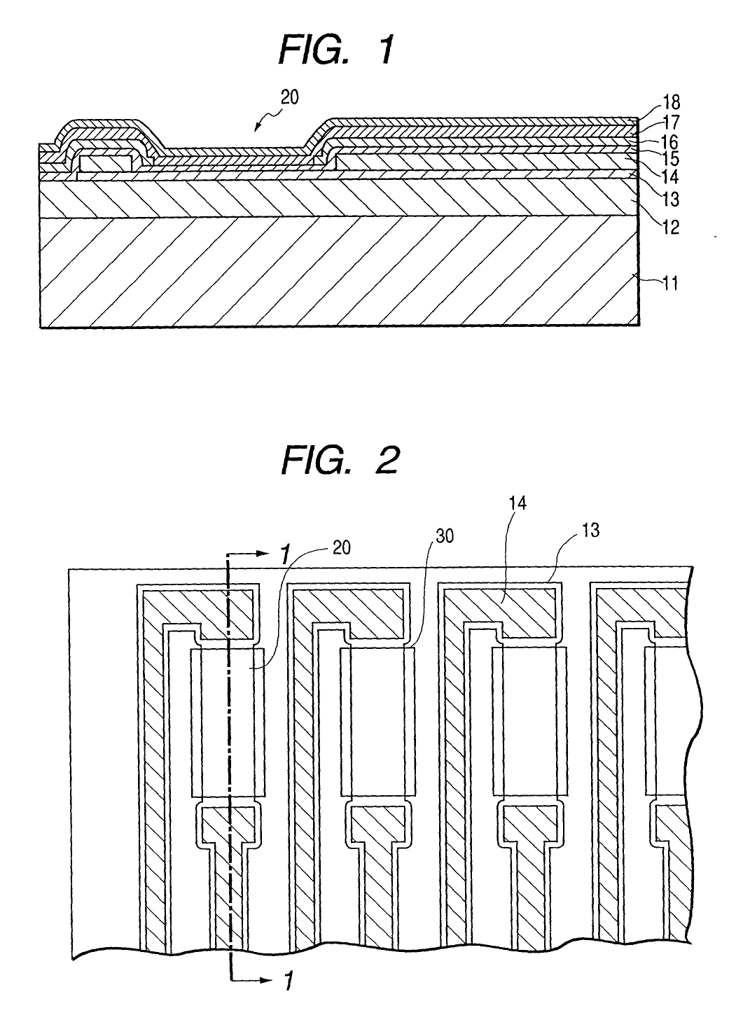

FIG. 2 is a typical plan view showing a main portion of a substrate for an ink jet recording head of the present invention. FIG. 1 is a typical side sectional view in which this main portion is cut by a one-dotted chain line 1-1 in FIG. 2.

As shown in FIGS. 1 and 2, a silicon oxide film as a heat accumulating layer 12 is formed on a silicon substrate 11, and aluminum layers as a heating resistor layer 13 and a wiring 14 are respectively formed in predetermined pattern shapes on this silicon oxide film. A heating portion 20 is formed by a portion of the heating resistor layer 13 between a pair of wirings 14.

A silicon nitride layer as a first layer protecting film 15, a silicon oxide layer as a second layer protecting film 16, a silicon nitride film as a third layer protecting film 17, and a tantalum (Ta) film as a cavitation resisting film 18 are sequentially formed such that the heating resistor layer 13 and the wiring 14 are covered with these films 15, 16, 17 and 18. The second layer protecting film 16 has an opening on the heating portion 20 of the heating resistor layer. Further, the cavitation resisting film 18 is arranged to mainly protect the substrate from impact at bubbling and debubbling times and cavitation destruction.

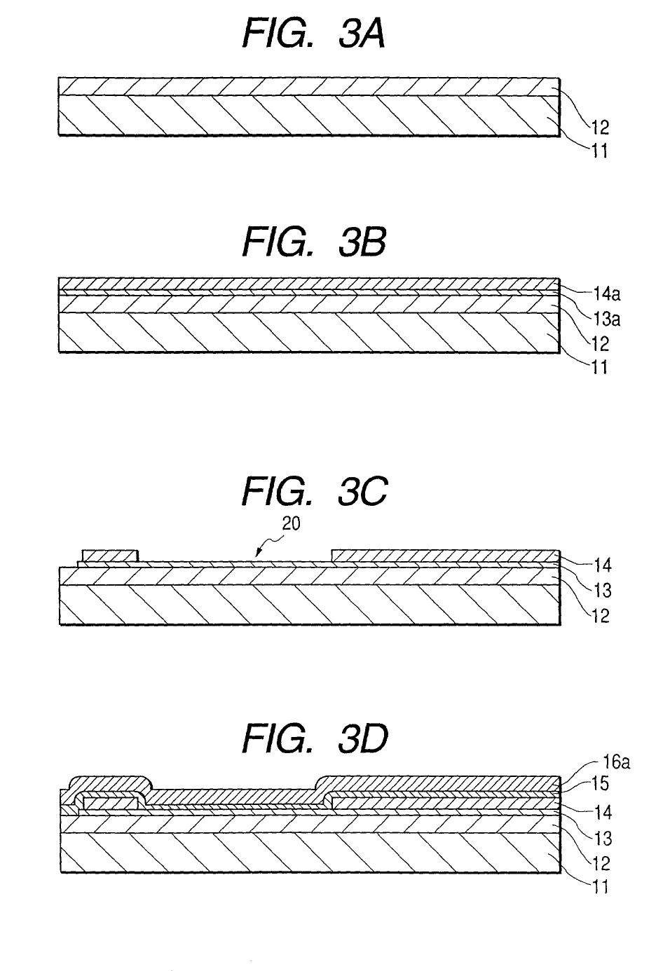

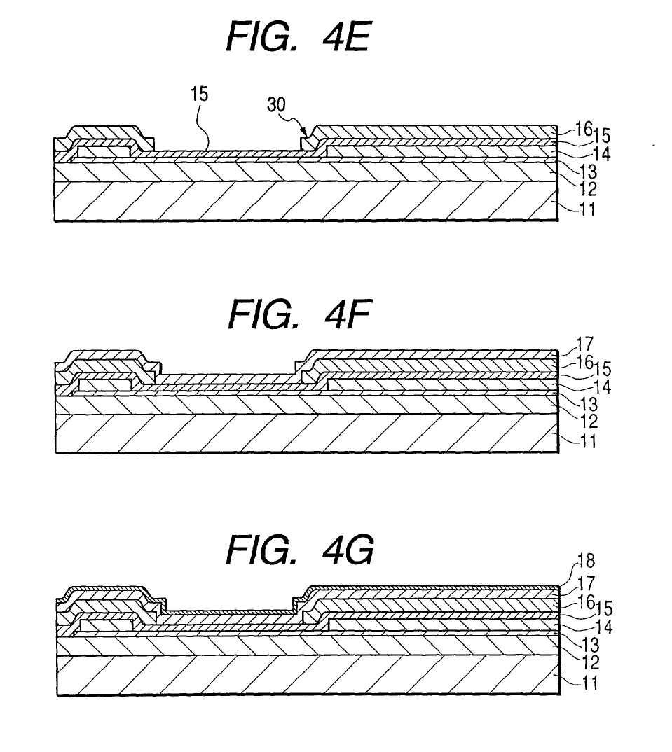

A manufacturing method of the substrate for the ink jet recording head having this structure will next be explained by using FIGS. 3A to 3D and FIGS. 4E to 4G.

As shown in FIG. 3A, a silicon oxide film constituting a heat accumulating layer 12 as the substrate of a heating resistor is formed on a silicon substrate 11 by a thermal oxidation method, a sputtering method, a CVD method, etc.

Next, as shown in FIG. 3B, a TaN layer 13a as a heating resistor layer 13 is formed on the heat accumulating layer 12 by reactive sputtering such that this TaN layer 13a has about 100 nm in thickness. Further, an aluminum layer 14a as a wiring 14 is formed on this TaN layer 13a by sputtering such that this aluminum layer 14a has 500 nm in thickness.

Next, the aluminum layer 14a is wet-etched by using a photolithography method and the TaN layer 13a is further reactively etched so that the wiring 14 and the heating resistor layer 13 each having a sectional shape as shown in FIG. 3C (see FIG. 1 with respect to a planar shape) are formed. In the heating portion 20, the aluminum layer 14a is removed from this heating portion 20 and the heating resistor layer 13 is exposed. Accordingly, heat is caused when an electric current flows through a pattern of the wiring 14.

Next, as shown in FIG. 3D, a silicon nitride film as a first layer protecting film 15 is formed by a CVD method such that this silicon nitride film has 200 μm in thickness. A silicon oxide film 16a as a second layer protecting film 16 is formed by the CVD method such that this silicon oxide film 16a has 500 nm in thickness.

Next, the silicon oxide film 16a on the heating portion 20 of the heating resistor is partially etched by using a photolithography method and a hydrogen fluoride liquid so that the second layer protecting film 16 is formed as shown in FIG. 4E. At this time, a step difference 30 is formed.

Next, as shown in FIG. 4F, silicon nitride as a third layer protecting film 17 is formed by using the CVD method such that this silicon nitride has 300 nm in thickness.

Next, as shown in FIG. 4G, tantalum (Ta) as a cavitation resisting film 18 is formed by the sputtering method such that this tantalum has 200 nm in thickness.

Finally, the tantalum (Ta) film and the first to third layer protecting films are etched by the photolithography method so that a pad of an aluminum electrode required for a connection with an external power source is exposed. Thus, manufacture of the main portion of the substrate for the ink jet recording head is completed.

The ink jet head is assembled by using the substrate for the ink jet recording head manufactured in this way. When performance of this ink jet head is checked, it is confirmed that power can be saved and life of the ink jet head can be extended.

### Embodiment 2

Similar to the embodiment 1, an ink jet recording head is manufactured except that silicon oxide doping boron or phosphorus thereinto is used as the second layer protecting film. As a result, an etching rate with respect to a hydrogen fluoride liquid is increased in speed, and a selecting ratio with respect to silicon nitride as a material of the first layer protecting film is further increased. Thus, damage of the first layer protecting film caused at an etching time of the second layer protecting film is reduced so that the thickness of the second layer protecting film can be further increased. Accordingly, a wiring layer can be further reliably protected while power is saved.

In the above embodiments, as shown in U.S. Pat. No. 4,429,321, an integrated circuit for operating the heating resistor may be made within the same silicon substrate. In this case, similar to a wiring portion, it is preferable to cover a portion of the integrated circuit with the first, second and third layer protecting films.

### Other embodiments

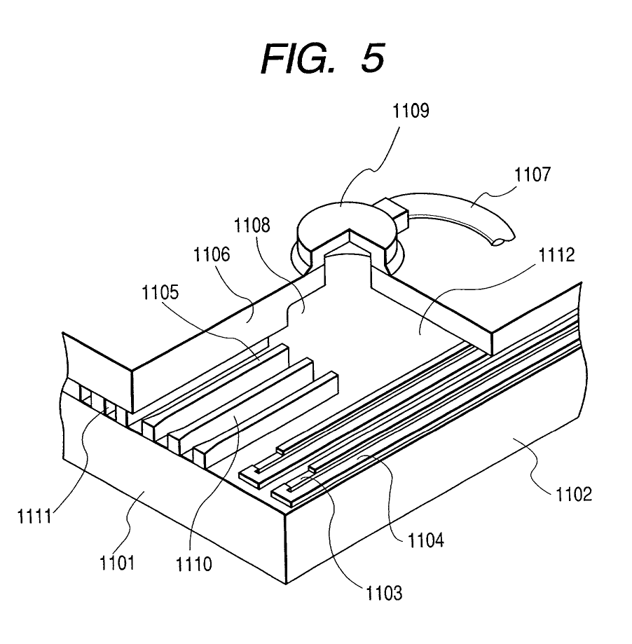

An ink jet head and an ink jet device capable of applying the substrate for the ink jet head of the present invention thereto will next be explained. FIG. 5 is a typical partially broken perspective view showing such an ink jet head. The ink jet head is constructed by an electrothermal converting element 1103, a wiring 1104, a liquid path wall 1105 and a roof plate 1106 formed as films on a substrate 1102 through semiconductor processes of etching, evaporation sputtering, etc.

A liquid 1112 for recording is supplied from an unillustrated liquid storing chamber into a common liquid chamber 1108 of the head 1101 through a liquid supplying tube 1107. In this figure, reference numeral 1109 designates a connector for the liquid supplying tube. The liquid 1112 supplied into the common liquid chamber 1108 is supplied into a liquid path 1110 by a so-called capillary phenomenon and is stably held by forming a meniscus on a discharging port face (an orifice face) of this liquid at an end tip of the liquid path.

Here, the liquid on a face of the electrothermal converting element is rapidly heated by flowing an electric current through the electrothermal converting element 1103 so that an air bubble is caused within the liquid path. The liquid is discharged from the discharging port 1111 by expansion and contraction of this air bubble so that a liquid drop is formed.

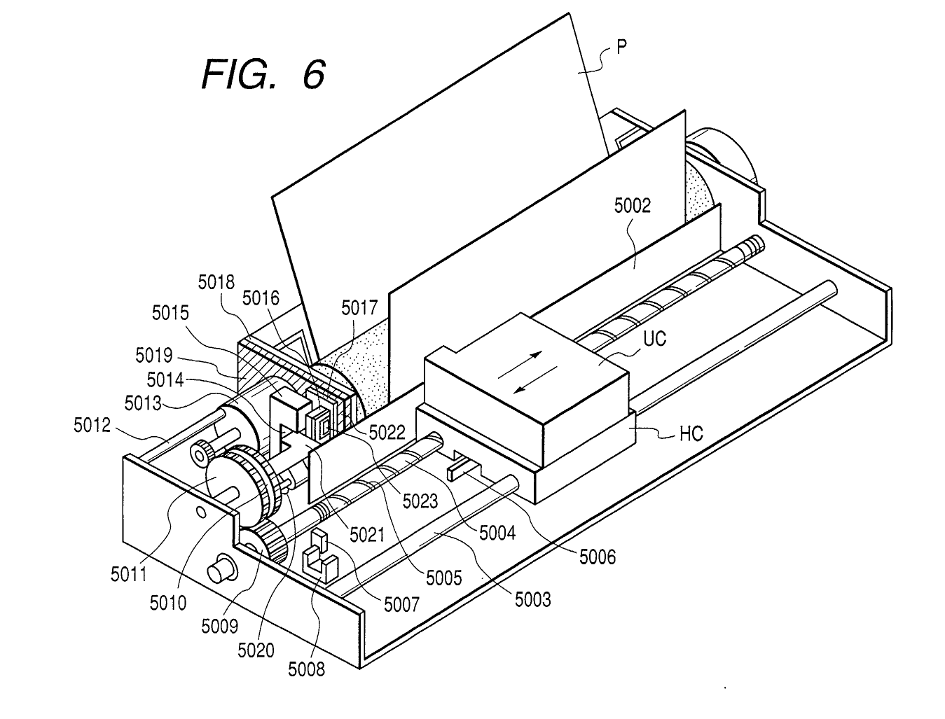

FIG. 6 is a typical perspective view showing a main portion of the ink jet device to which the present invention is applied. A carriage HC is engaged with a spiral groove 5005 of a lead screw 5004 rotated through driving force transmission gears 5011, 5009 in association with normal and reverse rotations of a drive motor 5013. The carriage HC has an unillustrated pin and is reciprocated in arrow directions. Reference numeral 5002 designates a paper pressing plate for pressing paper against a platen 5000 in a moving direction of the carriage. Photocouplers 5007, 5008 are home position detecting means for confirming the existence of a lever 5006 of the carriage in this area and switching the rotating directions of the motor 5013, etc.

Reference numeral 5016 designates a member for supporting a cap member 5022 for capping a front face of the recording head. Reference numeral 5015 designates a sucking means for sucking the interior of this cap and this sucking means 5015 performs a sucking recovery operation of the recording head through an opening 5023 within the cap. Reference numeral 5017 designates a cleaning blade and reference numeral 5019 designates a member capable of moving this blade in forward and backward directions. The clearing blade 5017 and this member 5019 are supported by a main body supporting plate 5018. A well-known cleaning blade having a shape instead of this shape of t he cleaning blade can be also applied to this example. Reference numeral 5012 designates a lever for starting suction of the sucking recovery. This lever 5012 is moved as a cam 5020 engaged with the carriage is moved. Driving force from the drive motor is controlled in this movement by a well-known transmission means such as a clutch switch, etc.

These capping, cleaning and sucking recovery portions are constructed such that desirable processing is performed in their corresponding positions by an operation of the lead screw 5004 when the carriage reaches a home position side area. However, each of these constructions can be applied to the present invention if a desirable operation is performed in well-known timing. The ink jet device has driving signal supplying means for operating an energy generating element for generating energy utilized to discharge the ink.

Waht is claimed is:

1. An ink jet recording head in which a heating resistor forming a heating portion, a wiring electrically connected to the heating resistor, and a protecting film formed on said heating resistor and said wiring to protect the heating resistor and the wiring are arranged on a substrate for the ink jet recording head, and an ink path communicated with a discharging port for discharging ink is formed on the substrate for the ink jet recording head, said protecting film including a first layer protecting film for covering said heating resistor and said wiring, a second layer protecting film formed on the first layer protecting film by a material different from that of the first layer protecting film and having an opening in a portion corresponding to said heating portion of said heating resistor and constructed by an inorganic material, and a third layer protecting film constructed by the same material system as said first layer protecting film and covering said second layer protecting film and said first layer protecting film exposed from said opening.

2. The ink jet recording head according to claim 1, wherein said second layer protecting film is formed by a material having an etching speed higher than that of said first layer protecting film.

3. The ink jet recording head according to claim 1, wherein said second layer protecting film is constructed by the same material system as said first layer protecting film.

4. The ink jet recording head according to claim 3, wherein said first, second and third layer protecting films are constructed by a material including silicon.

5. The ink jet recording head according to claim 4, wherein said first and third layer protecting films are constructed by silicon nitride, and said second layer protecting film is constructed by silicon oxide.

6. The ink jet recording head according to claim 5, wherein said second layer protecting film is constructed by silicon oxide including boron or/and phosphorus.

7. The ink jet recording head according to claim 1, wherein a cavitation resisting film is further formed on said third layer protecting film.

8. The ink jet recording head according to claim 7, wherein said cavitation resisting film is formed by tantalum.

9. The ink jet recording head according to claim 1, wherein a basic material of said substrate is constructed by silicon.

10. The ink jet recording head according to claim 1 or 9, wherein said substrate has a heat accumulating layer at least on a forming side of said heating portion.

11. The ink jet recording head according to claim 10, wherein said heat accumulating layer is constructed by silicon oxide.

12. The ink jet recording head according to claim 1, wherein the ink is discharged from said discharging port on the basis of film boiling caused in the ink by utilizing thermal energy generated from said heating portion.

13. A substrate for an ink jet recording head in which a heating resistor forming a heating portion, a wiring electrically connected to the heating resistor, and a protecting film formed on said heating resistor and said wiring to protect the heating resistor and the wiring are arranged on the substrate, said protecting film including a first layer protecting film for covering said heating resistor and said wiring, a second layer protecting film formed on the first layer protecting film by a material different from that of the first layer protecting film and having an opening in a portion corresponding to said heating portion of said heating resistor and constructed by an inorganic material, and a third layer protecting film constructed by the same material system as said first layer protecting film and covering said second layer protecting film and said first layer protecting film exposed from said opening.

14. The substrate for the ink jet recording head according to claim 13, wherein said second layer protecting film is formed by a material having an etching speed higher than that of said first layer protecting film.

15. The substrate for the ink jet recording head according to claim 13, wherein said second layer protecting film is constructed by the same material system as said first layer protecting film.

16. The substrate for the ink jet recording head according to claim 15, wherein said first, second and third layer protecting films are constructed by a material including silicon.

17. The substrate for the ink jet recording head according to claim 16, wherein said first and third layer protecting films are constructed by silicon nitride, and said second layer protecting film is constructed by silicon oxide.

18. The substrate for the ink jet recording head according to claim 17, wherein said second layer protecting film is constructed by silicon oxide including boron or/and phosphorus.

19. The substrate for the ink jet recording head according to claim 13, wherein a cavitation resisting film is further formed on said third layer protecting film.

20. The substrate for the ink jet recording head according to claim 19, wherein said cavitation resisting film is formed by tantalum.

21. The substrate for the ink jet recording head according to claim 13, wherein a basic material of said substrate is constructed by silicon.

22. The substrate for the ink jet recording head according to claim 13 or 21, wherein said substrate has a heat accumulating layer at least on a forming side of said heating portion.

23. The substrate for the ink jet recording head according to claim 22, wherein said heat accumulating layer is constructed by silicon oxide.

24. A manufacturing method of a substrate for an ink jet recording head in which a heating resistor forming a heating portion, a wiring electrically connected to the heating resistor, and a protecting film formed on said heating resistor and said wiring to protect the heating resistor and the wiring are arranged on the substrate, said method comprising the steps of:
forming a first layer protecting film so as to cover said heating resistor and said wiring;
forming a film of an inorganic material different from a material of the first layer protecting film on said first layer protecting film;
etching the film of said inorganic material in a portion corresponding to said heating portion of said heating resistor and removing this inorganic material film from this corresponding portion so that a second layer protecting film having an opening in said corresponding portion is formed; and
forming a third layer protecting film of the same material system as said first layer protecting film so as to cover said second layer protecting film and said first layer protecting film exposed from said opening.

25. An ink jet recording apparatus characterized in that the ink jet recording apparatus comprises the ink jet recording head described in claim 1 and a member for mounting this ink jet recording head.
